(19) United States
(12) Patent Application Publication
(10) Pub. No.: US 2007/0227067 A1
(43) Pub. Date: Oct. 4, 2007

(54) PLASTIC CONTAINER WITH TAG SLOT

(76) Inventor: Alfons Sieverding, Lohne (DE)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/619,816

(22) Filed: Jan. 4, 2007

(30) Foreign Application Priority Data
Mar. 28, 2006 (DE) 20 2006 004 925.8

(51) Int. Cl. A01G 9/02

(52) U.S. Cl. 47/65.5

(57) ABSTRACT

A container made of plastic, in particular a deep-drawn plant pot, includes a top container edge that is oriented primarily horizontally, adjacent to which is at least one container wall that is oriented primarily downward. The container wall has at least one slot that matches the container edge for a tag that is provided with a shank. The slot has two slot edges that are offset vertically from each other, whereby the slot edge that is offset from the container wall is lower than the slot edge that is adjacent to the container wall. Good retention and firm seating of the tag is realized, even with increasingly thinner-walled containers and narrower container edges.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to a plastic container and, more specifically, to a deep-drawn plant pot.

### BACKGROUND OF THE INVENTION

Containers with slots for insertable tags are known in the nursery industry in a variety of forms, such as plant pots, palettes, trays etc. Slots are thereby provided for the insertion of tags made of a flat material such as cardboard, plastic, metal, or composite film into a slot on the edge of the containers so as to display information concerning the product, the price, etc., on the tag.

Both the containers and the tags must thereby be designed, if necessary, in coordination with each other, to meet practical requirements in terms of fast and easy insertion, so that the tags can be affixed to the container with an insertion movement that is as fast and easy as possible. The tags must also be firmly and reliably seated not only to regularly prevent them from accidentally falling out, but also to prevent any potential undesirable tampering, such as the accidental or deliberate switching of tags on retail items. For this purpose, locking means are already provided on conventional containers that interact with barbed or serrated edges on the tag.

There are particular problems in the design of tag slots resulting from the trend toward increasingly thinner-walled containers and narrower container edges, which offer very little space for the tag slots, and from an elementary slot shape that also provides very little footing to prevent the tag from tipping or folding inward.

### SUMMARY OF THE INVENTION

The invention teaches that the resulting problems are solved by a container of the type described in the introduction to claim 1, beginning with the characterizing features disclosed in the claim. The three-dimensional design of such a slot from the simple, flat surface of the container edge can be created even with a thin-walled material and a narrow container edge, and makes it possible to specify the orientation of the tag with the edges of the slot that are vertically offset from each other, whereby the bottom portion of the tag is directed with the shank toward the container wall, thereby counteracting a bending of the tag inward, and whereby the shank is bent away from the wall. In the opposite direction, the container wall offers a contact surface for the shank that secures the tag and prevents it from tipping toward the outside. This design makes it possible to prevent an undesirable hinge action that occurs in the vicinity of the edge of the container, in particular on thin-walled containers.

The three-dimensional design of the slot with slot edges that are vertically offset from each other can also be integrated into the deep drawing process for deep-drawn containers, including in particular deep-drawn plant pots, in which stamping or punching movements are already conventionally provided at the conclusion of the deep drawing process for a separation of the container from the initial film.

The slot can thereby be straight or curved, for example, to match a curved profile of the container edge. In both cases, there can be a vertical offset between the slot edges over the entire length of the slot, whereby the outboard edge is preferably not only lower than the inboard edge, but also lower than the surface of the container edge, and ending abruptly on a transversely oriented terminal section of the slot.

The slot edge, which is thereby structured in the manner of a barb or a flexible tab, can form a flexible lock with respect to an inserted tag, which tightly grips the reverse edges of the insertable tag from behind. However, on account of a beveled edge that slopes toward the slot or tag, the slot edge can also form a barbed surface that can be hooked from behind by a retaining lug of the tag.

The container edge can be shaped downward in an otherwise conventional manner on the outside, the result of which is that sharp peripheral and dangerous edges that can cause discomfort during handling can be avoided. By interaction with a slot of the type provided here, however, the container edge also conceals the underside of the slot, and, if necessary, the areas of a tag that interact with the underside of the slot, thereby making undesirable tampering more difficult.

In coordination with a container slot of this type, a tag can be provided in the vicinity of its shank with at least one retaining lug that points in the opposite direction of the direction in which the tag is inserted. A retaining lug of this type can be realized so that it is particularly strong in the vicinity of the shank on the inside and also makes it possible to provide the shank (which conventionally tapers toward the end or comes to a point) with smooth edges (which makes possible a fast and smooth insertion). An inboard retaining lug can be given a positive contour that curves outward to stiffen it and to guarantee the desired locking action at the end of the insertion.

### BRIEF DESCRIPTION OF THE DRAWINGS

One embodiment of the present invention is illustrated in the accompanying drawings and is explained in greater detail below. In the figures:

FIGS. 1 and 2 are views of a plant pot from diagonally overhead and from directly overhead, respectively;

FIGS. 3 and 4 show the plant pot illustrated in FIGS. 1 and 2 with inserted tags, from diagonally overhead and from directly overhead, respectively;

FIGS. 5 and 6 are partial sections of the peripheral area of the plant pot without the tag and with the tag, respectively;

FIGS. 7 and 8 are details from below in the direction indicated by the Arrow VII in FIG. 5 and Arrow VIII in FIG. 6; and

FIGS. 9 and 10 are sectional drawings along line IX-IX in FIG. 5 and line X-X in FIG. 6.

### DETAILED DESCRIPTION OF CERTAIN PREFERRED EMBODIMENTS

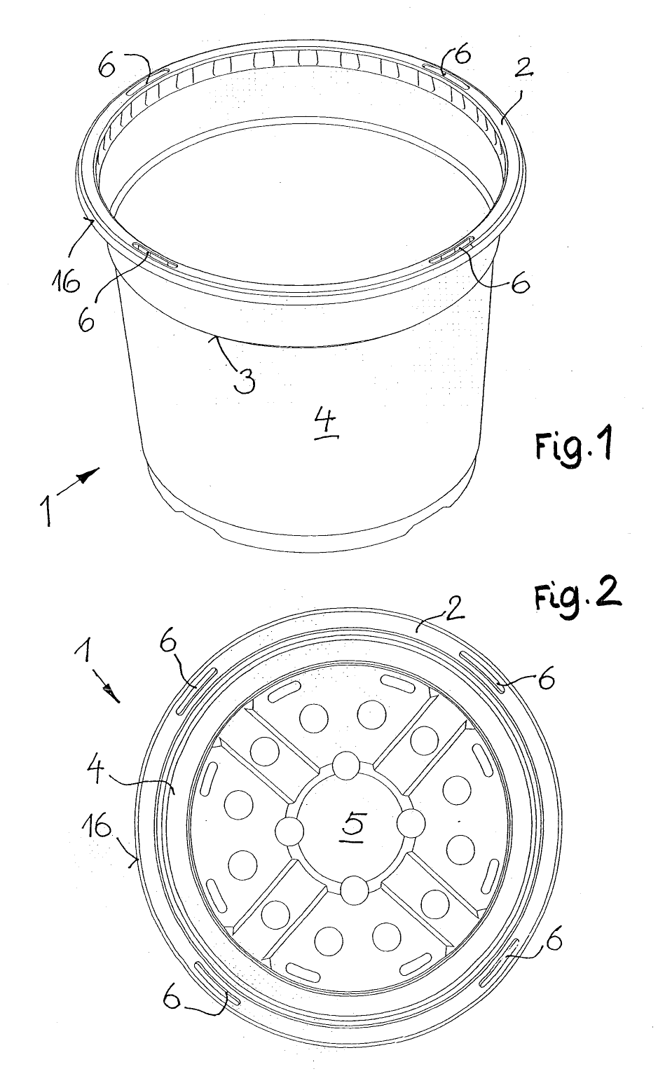

FIGS. 1 and 2 show a plant pot (1) in a deep-drawn, thin-walled realization in the form of a round pot with a narrow, ring-shaped, flat container edge (2) and a container wall (4) that is stepped at a shoulder (3) in the conventional basic shape of the envelope of a truncated cone, which makes the transition on the underside into a profiled pot bottom (5) that is provided with holes. The container edge (2) is provided with four matching slots (6) that are uniformly offset from one another with an angle at the circumference of 90°, are slightly curved to match the profile of the container edge, and are used for the insertion of tags.

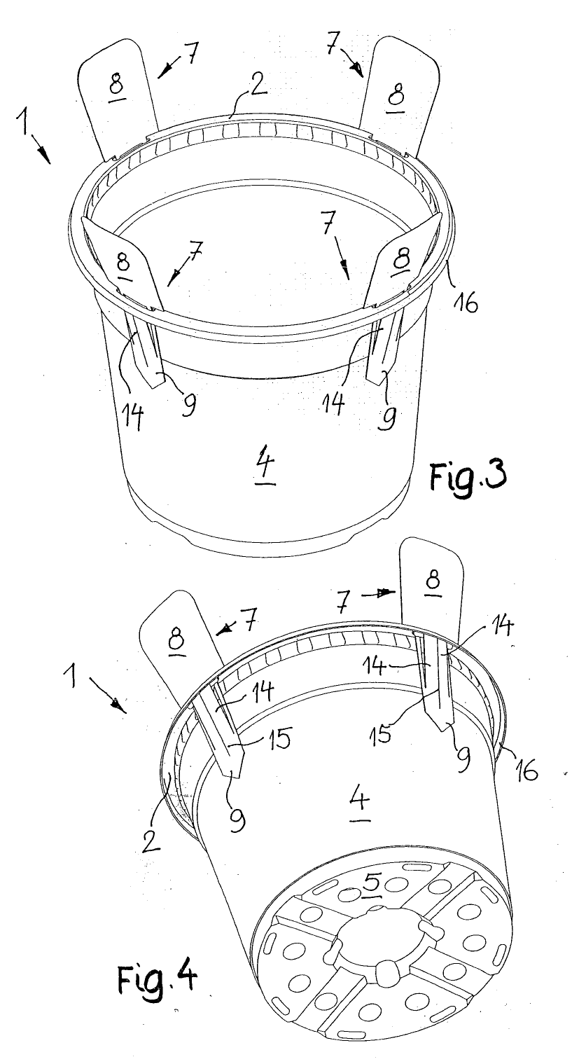

In FIGS. 3 and 4, the plant pot (1) contains matching tags (7) in all four slots (6), which tags have a tag panel on the top (8) for illustrations, text, and other information, and a shank (9) on the bottom for anchoring to the pot (1). It goes without saying that, depending on the requirements of actual practice, different tags can be inserted into the slots, as well as, if necessary, a lower number of tags (7).

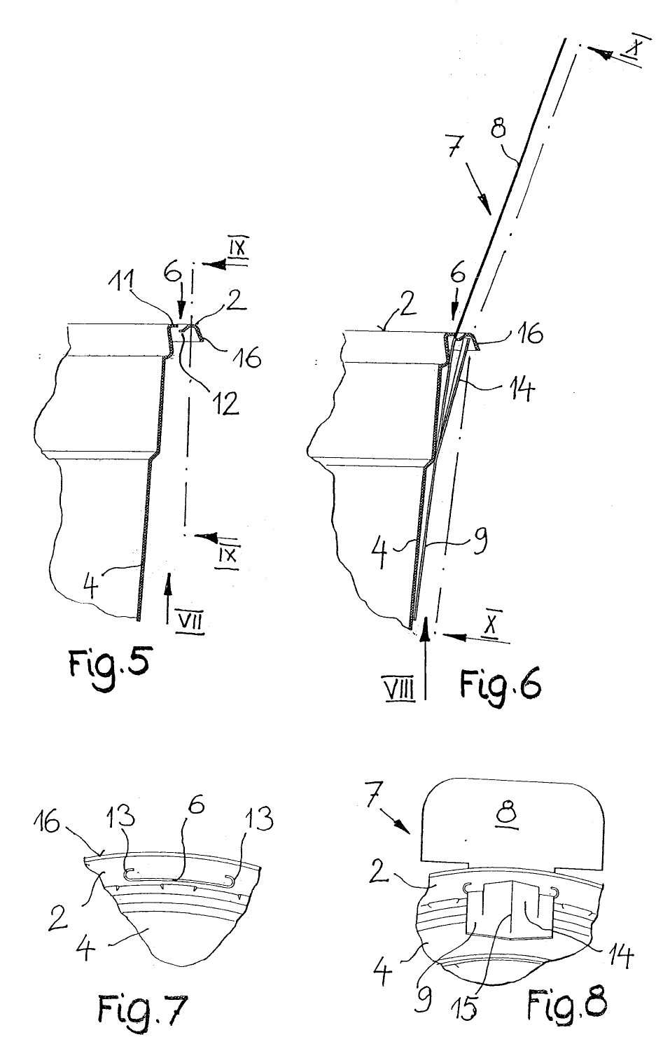

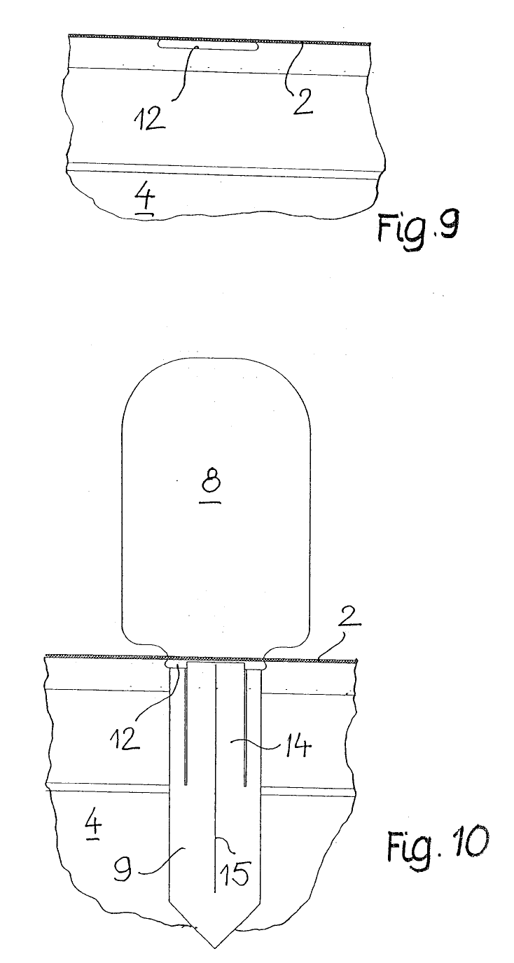

As shown in the sectional drawing in FIG. 5, a slot does not lie in its entirety within the plane of the container edge (2), but is shaped in three dimensions so that only a slot edge (11) that lies inward toward the container wall (4) remains inside the plane of the container edge (6), while on the other hand an outboard slot edge (12) slopes diagonally downward. This arrangement makes it possible to punch a slot in the wall for which, in an overhead view, no open slot width has to be specified. For the insertion of a tag (7) with its shank (9), there is already an opening width that results from the lowering of the slot edge (12), which, taking into account the spring action of the slot edge (12), can be considered to provide a tight seat for the tag. Simultaneously, for the slot (6), there is an orientation of the slot opening which, viewed from top to bottom, i.e., in the direction of insertion of a shank, points toward the container wall (4).

FIG. 6 is a longitudinal section that shows the interaction of the slot (6) with the inserted tag (7) or with the shank (9) of the tag (7). The tag has a predominantly vertical orientation pointing slightly outward, while the shank that extends downward through the slot (6) is bent at a slight angle, and fixes the tag in its position with a certain amount of bias.

As shown clearly in FIG. 7, the slot (6) is provided on both ends with a transversely oriented terminal part (13) that ends in the shape of a semicircle, which creates a continuous punched line to the end, and also, among other things, creates a two-dimensional shape of the lower slot edge (12) to the end of the slot (6) without undesirably increasing the flexibility at the end of the slot. This configuration makes possible a clean realization of the slot during the manufacture of the pot, in particular during deep drawing, and guarantees that the desired geometry of the slot can be preserved toward its ends.

As shown in particular in FIGS. 3, 4, 6 and 8, the tag (7) is equipped with an inboard retaining lug (14) in the vicinity of its shank (9). The outer edges of the respective shank (9) can be realized so that they are straight or in any case smooth from one pointed terminal area to the tag panel (8), which facilitates the insertion of the tag.

After the insertion, the retaining lug (14) grips the lower slot edge (12) from behind, so that the tag cannot be easily pulled out. Rather, after a backward movement, as illustrated in FIG. 6, the retaining lug (14) is bent outward from the underside beveled edge of the lower slot edge. The hooking action of the retaining lug (14) is assisted by a positive contour (15) in the center that runs in the insertion direction, stiffens the retaining lug (14), and also unfolds or arches outward.

As shown in FIGS. 5 and 6, the essentially horizontal, flat container periphery (2) ends with a peripheral edge (16) that is bent downward, which conventionally serves to stiffen the edge and to facilitate handling of the container, which therefore has smooth edges. In this case, the container periphery with its bent peripheral edge (16) also contains a terminal portion of the retaining lug (14), to thereby lock it in place and also make it inaccessible to any potential attempts at tampering.

With the configurations of a container and tag described above, it has become possible, even in containers with low wall thicknesses and narrow container edges, to conserve material and save space, and to create a tag holder with a stable seat that provides protection against tampering, whereby the tag can be inserted into the container in a particularly simple insertion motion.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. Container (1) made of plastic comprising a top container edge (2) that is oriented primarily horizontally, adjacent to which is at least one container wall (4) that is oriented primarily downward, whereby the container wall (2) has at least one slot (6) that matches the container edge for a tag (7) that is provided with a shank (9), wherein the slot (6) is realized with two slot edges (11, 12) which are offset vertically from each other, whereby the slot edge (12) that is set off from the container wall (4) is lower than the slot edge (11) that is adjacent to the container wall (4).

2. Container as recited in claim 1, wherein the slot (6) is provided at least on one end with a transversely oriented terminal section (13).

3. Container as recited in claim 2, wherein the terminal section (13) of the slot (6) is a continuation of the container wall (4).

4. Container as recited in claim 3, wherein the terminal section (13) is realized in a curved shape.

5. Container as recited in one of the claim 4, wherein the slot is curved.

6. Container as recited in one of the claim 3, wherein the slot is curved.

7. Container as recited in claim 2, wherein the terminal section (13) is realized in a curved shape.

8. Container as recited in one of the claim 2, wherein the slot is curved.

9. Container as recited in one of the claim 1, wherein the slot is curved.

10. Container as recited in claim 1, wherein the container edge (2) is shaped so that it slopes downward toward the slot (6).

11. Container as recited in claim 1, further comprising a tag (7) with a shank (9) that is inserted into the slot (6), and wherein the shank (9) is supported on the container wall (4).

12. Container as recited in claim 11, wherein the tag (7) has, on its shank (9), at least one retaining lug (14) that points opposite to the insertion direction.

13. Container as recited in claim 12, wherein the retaining lug (14) is formed in one piece with the tag (7) with a contour that is manufactured from flat primary material.

14. Container as recited in claim 13, wherein the tag (7), at least in the vicinity of the retaining lug (14) has a positive contour (15) that runs in the insertion direction and bends the retaining lug (14) outward.

15. Container as recited in claim 14, wherein the container edge (2) is shaped so that it slopes downward toward the slot (8) and wherein the retaining lug (14) of the tag (7) that is inserted into the slot (6) is covered on the end by the downwardly shaped peripheral edge (16) of the container edge (2).

16. Container as recited in claim 13, wherein the container edge (2) is shaped so that it slopes downward toward the slot (8) and wherein the retaining lug (14) of the tag (7) that is inserted into the slot (6) is covered on the end by the downwardly shaped peripheral edge (16) of the container edge (2).

17. Container as recited in claim 12, wherein the tag (7), at least in the vicinity of the retaining lug (14) has a positive contour (15) that runs in the insertion direction and bends the retaining lug (14) outward.

18. Container as recited in claim 17, wherein the container edge (2) is shaped so that it slopes downward toward the slot (8) and wherein the retaining lug (14) of the tag (7) that is inserted into the slot (6) is covered on the end by the downwardly shaped peripheral edge (16) of the container edge (2).

19. Container as recited in claim 12, wherein the container edge (2) is shaped so that it slopes downward toward the slot (8) and wherein the retaining lug (14) of the tag (7) that is inserted into the slot (6) is covered on the end by the downwardly shaped peripheral edge (16) of the container edge (2).

20. Container as recited in claim 1, wherein the container is a deep-drawn plant pot.
